(19) United States
(12) Patent Application Publication
(10) Pub. No.: US 2024/0161470 A1
(43) Pub. Date: May 16, 2024

(54) Machine-Learned Models for Implicit Object Representation

(71) Applicant: Google LLC, Mountain View, CA (US)

(72) Inventors: Cristian Sminchisescu, Zürich (CH); Thiemo Andreas Alldieck, Zürich (CH); Hongyi Xu, Zürich (CH)

(21) Appl. No.: 18/549,617

(22) PCT Filed: Apr. 21, 2021
(86) PCT No.: PCT/US2021/028303

§ 371 Date: Sep. 8, 2023

(51) Int. Cl. G06V 10/774; G06T 7/50; G06T 15/80; G06T 17/20; G06V 10/26; G06V 10/776; G06V 20/64; G06V 20/70; G06V 40/10

(52) U.S. Cl. CPC G06V 10/774; G06T 7/50; G06T 15/80; G06T 17/20; G06V 10/26; G06V 10/776; G06V 20/64; G06V 20/70; G06V 40/10; G06T 2200/04

(57) ABSTRACT

Systems and methods of the present disclosure are directed to a computer-implemented method for training a machine-learned model for implicit representation of an object. The method can include obtaining a latent code descriptive of a shape of an object comprising one or more object segments. The method can include determining spatial query points. The method can include processing the latent code and spatial query points with segment representation portions of a machine-learned implicit object representation model to obtain implicit segment representations for the object segments. The method can include determining an implicit object representation of the object and semantic data. The method can include evaluating a loss function. The method can include adjusting parameters of the machine-learned implicit object representation model based at least in part on the loss function.

### FIELD

The present disclosure relates generally to implicit object representation. More particularly, the present disclosure relates to training and utilization of machine-learned models for implicit object representation.

### BACKGROUND

Accurate, three-dimensional representation of objects has become increasingly necessary in a broad variety of technical fields (e.g., medical diagnosis and treatment, video editing, image synthesis, video game asset creation, etc.). Conventionally, three-dimensional object representations are explicitly defined. For example, a human body can be represented by a three-dimensional polygonal mesh.

However, explicit representation of objects presents a number of inherent difficulties. As an example, explicit representation of human bodies generally utilize a standard template, which makes representation of non-standard body types prohibitively difficult (e.g., amputees, disabled peoples, etc.). As another example, explicit representations are generally discretized, which necessitates interpolation when querying structural information and/or “snapping” to discrete samples. In contrast, implicit object representations are defined continuously, which facilitates structural information querying at any particular point of the object.

Thus, the generation of implicit representations of three-dimensional objects eliminates the difficulties and inefficiencies inherent to explicit object representation while also maintaining or surpassing the accuracy of explicit object representation.

### SUMMARY

Aspects and advantages of embodiments of the present disclosure will be set forth in part in the following description, or can be learned from the description, or can be learned through practice of the embodiments.

One example aspect of the present disclosure is directed to A computer-implemented method for training a machine-learned model for implicit representation of an object. The method can include obtaining, by a computing system comprising one or more computing devices, a latent code descriptive of a shape of an object comprising one or more object segments. The method can include determining, by the computing system, a plurality of spatial query points within a three-dimensional space that includes the object. The method can include processing, by the computing system, the latent code and each of the plurality of spatial query points with one or more segment representation portions of a machine-learned implicit object representation model to respectively obtain one or more implicit segment representations for the one or more object segments. The method can include determining, by the computing system based at least in part on the one or more implicit segment representations, an implicit object representation of the object and semantic data indicative of one or more surfaces of the object. The method can include evaluating, by the computing system, a loss function that evaluates a difference between the implicit object representation and ground truth data associated with the object and a difference between the semantic data and the ground truth data associated with the object. The method can include adjusting, by the computing system, one or more parameters of the machine-learned implicit object representation model based at least in part on the loss function.

Another aspect of the present disclosure is directed to a computing system featuring a machine-learned implicit object representation model with at least one or more segment representation portions trained to implicitly represent segments of an object. The computing system can include one or more processors. The computing system can include one or more non-transitory computer-readable media that collectively store a machine-learned implicit object representation model. The machine-learned implicit object representation model can include one or more segment representation portions, wherein each of the one or more segment representation portions is respectively associated with one or more object segments of an object, wherein each of the one or more segment representation portions is trained to process a latent code descriptive of a shape of the object and a set of localized query points to generate an implicit segment representation of a respective object segment of the one or more object segments. The machine-learned implicit object representation model can include a fusing portion trained to process one or more implicit segment representations to generate an implicit object representation and semantic data indicative of one or more surfaces of the object, wherein at least the one or more segment representation portions of the machine-learned implicit object representation model have been trained based at least in part on a loss function that evaluates a difference between the implicit object representation and ground truth data associated with the object and a difference between the semantic data and the ground truth data associated with the object.

Another aspect of the present disclosure is directed to one or more tangible, non-transitory computer readable media storing computer-readable instructions that when executed by one or more processors cause the one or more processors to perform operations. The operations can include obtaining a latent code descriptive of a shape of an object comprising one or more object segments. The operations can include determining a plurality of spatial query points within a three-dimensional space that includes the object. The operations can include processing the latent code and each of the plurality of spatial query points with one or more segment representation portions of a machine-learned implicit object representation model to an implicit object representation and semantic data indicative of one or more surfaces of the object. The operations can include determining, based at least in part on the one or more implicit segment representations, an implicit object representation of the object and semantic data indicative of one or more surfaces of the object. The operations can include extracting, from the implicit object representation, a three-dimensional mesh representation of the object comprising a plurality of polygons.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that performs training and utilization of machine-learned implicit object representation models according to example embodiments of the present disclosure.

FIG. 1B depicts a block diagram of an example computing device that generates implicit object representations according to example embodiments of the present disclosure.

FIG. 1C depicts a block diagram of an example computing device that performs training of machine-learned implicit object representation models according to example embodiments of the present disclosure.

FIG. 2 depicts a block diagram of an example machine-learned implicit object representation model according to example embodiments of the present disclosure.

FIG. 3 depicts a block diagram of an example machine-learned implicit object representation model according to example embodiments of the present disclosure.

FIG. 4 depicts a data flow diagram for training an example machine-learned implicit object representation model according to example embodiments of the present disclosure.

FIG. 5 depicts a data flow diagram for utilization of a machine-learned implicit object representation model according to example embodiments of the present disclosure.

FIG. 6 depicts a flow chart diagram of an example method to perform implicit object representation according to example embodiments of the present disclosure.

Reference numerals that are repeated across plural figures are intended to identify the same features in various implementations.

### DETAILED DESCRIPTION

### Overview

Generally, the present disclosure is directed to computing system which perform implicit object representation such as an implicit generative approach for human pose. More particularly, the present disclosure relates to training and utilization of machine-learned implicit object representation models for generation of implicit representations for objects such as human bodies. As an example, a latent code can be obtained that describes an object (e.g., a shape and pose of a human body, etc.). The object described by the latent code can include one or more object segments. For example, if the object is a human body, the object can include arm, torso, leg, and foot segments. A plurality of spatial query points can be determined within a three dimensional space that includes the object (e.g., arbitrary points within a volumetric space that includes the object, etc.). Each of the spatial query points can be processed alongside the latent code using one or more segment representation portions of a machine-learned implicit object representation model to obtain one or more implicit segment representations for the object segment(s) (e.g., a head representation and a torso representation for head and torso segments of a human body object, etc.). Based at least in part on the implicit segment representation(s), an implicit object representation and semantic data associated with the object can be determined. The semantic data can be indicative of one or more surfaces of the object (e.g., corresponding polygons of a mesh representation, etc.). Afterwards, three-dimensional mesh representation can be extracted from the implicit representation (e.g., using a marching cubes algorithm, etc.), and can be shaded or otherwise modified based on the semantic data. In such fashion, an implicit representation of the object can be generated that is capable of later conversion to an explicit representation for various tasks.

More particularly, a latent code descriptive of a shape of an object can be obtained. The latent code can describe a shape of an object (e.g., clothing, a human body, an animal body, a vehicle, furniture, etc.). In some implementations, the latent code can include a plurality of shape parameters indicative of the shape of the object and/or a plurality of pose parameters indicative of a pose of the object. a include pose of the object. The object can include one or more object segments. For example, if the object is a human body, the object can include various segment(s) of the human body (e.g., one or more arm segments, one or more foot segments, one or more hand segments, one or more leg segments, a body segment including a portion of the human body, a full-body segment including the entire human body, a face segment, ahead segment, a torso segment, etc.). As an example, the object can be a human body that includes a number of human body segments (e.g., arms, legs, torso, head, face, etc.). The latent code can be or otherwise include shape and/or pose kinematics θ∈R¹²⁴. Each kinematic θ can represent a set of joint transformations T(θ, j)∈R^{J×3×4} from the neutral to a posed state, where j∈R^{J×3} can represent the joint centers that are dependent on the neutral body shape. The shape of the body included in the latent code can be represented using a nonlinear embedding β_{b}∈R¹⁶. In addition to skeleton articulation, the latent code can, in some implementations, include or otherwise represent a facial expression of the human body as nonlinear latent code β_{f}∈R²⁰, giving an overall latent code represented as α=(β_{b}, β_{f}, θ).

In some implementations, the latent code can be generated based at least in part on two-dimensional image data that depicts the object. As an example, the two-dimensional image data can be processed using a machine-learned model configured to generate a latent representation of the shape and/or pose of the object. Alternatively, or additionally, in some implementations, the latent code can be generated based on three-dimensional image data that depicts the object.

A plurality of spatial query points can be determined within a three-dimensional space that includes the object. As an example, a spatial query point can exist in a three-dimensional space that includes a representation of the object (e.g., a volumetric space that includes a three-dimensional representation of the object, etc.). More particularly, the spatial query point can be located outside of the volume of the representation of the object, and can be located a certain distance away from a surface of the object. The plurality of spatial query points can be arbitrarily determined at various distances from the surface(s) of the representation of the object. For example, the plurality of spatial query points may be or otherwise appear as plurality of points external to the object, and scattered in three dimensions at various distances from the object.

Alongside the latent code, each of the plurality of spatial query points can be processed using one or more segment representation portions (e.g., one or more multi-layer perceptron(s), etc.) of a machine-learned implicit object representation model (e.g., one or more multi-layer perceptron(s), etc.) to obtain one or more respective implicit segment representations (e.g., one or more signed distance function(s), etc.) for the one or more object segments. As an example, the object can be a human body object that includes a torso segment and ahead segment. The machine-learned implicit object representation model can include two segment representation portions: a first segment representation portion associated with the torso segment and a second segment representation portion associated with the head segment. The first segment representation portion can process the latent code and each of the spatial query points to obtain an implicit segment representation for the torso segment. The second segment representation portion can process the latent code and each of the spatial query points to obtain an implicit segment representation (e.g., a plurality of signed distance functions, etc.) for the head segment. As such, a respective segment representation portion for each segment of an object can be included in the machine-learned implicit object representation model.

In some implementations, the implicit segment representation portion(s) obtained with the machine-learned implicit object representation model can be or otherwise include signed distance function(s). As an example, given a latent representation a descriptive of the shape and pose of a human body, the posed body can be modeled as the zero iso-surface decision boundaries of Signed Distance Functions (SDFs) given by the machine-learned implicit object representation model (e.g., deep feed-forward neural network(s), multi-layer perceptron(s), etc.). A signed distance S(p,α)∈R can be or otherwise represent a continuous function that given an arbitrary spatial point p∈R³, outputs the shortest distance to the surface defined by α, where the sign can indicate the inside (e.g., a negative value) or outside (e.g., a positive value) with regards to the surface of the object. The posed human body surface can be implicitly provided by S(⋅, α)=0. As such, the implicit representation of the object can be estimated as a signed distance value s=S(p,α) for each arbitrary spatial point p.

As another example, the object can be a human body including a single body segment, and the machine-learned implicit object representation model can include a single segment representation portion associated with the body segment. Given the latent code descriptive of the shape of the body α=(β_{b},β_{f},θ), an implicit representation S(p,α) can be obtained that approximates the shortest signed distance to Y for any query point p. It should be noted that, in some implementations, Y can be or otherwise include arbitrary meshes, such as raw human scans, mesh registrations, or explicit mesh samplings. The zero iso-surface S(⋅, α)=0 is sought to preserve all geometric detail in Y, including body shapes and poses, hand articulation, and facial expressions.

To follow the previous example, the machine-learned implicit object representation model can, in some implementations, be or otherwise include one global neural network that is configured to determine the implicit representation S(p,α) for a given latent code α and a spatial point p. More particularly, the machine-learned implicit object representation model can be or otherwise include one or more MLP network(s) S(p,α; ω) configured to to output a solution to the Eikonal equation:

∥∇ₚS(p,α;ω)∥=1, (1)

where S can represent a signed distance function that vanishes at the surface Y with gradients equal to surface normals. For example, the total loss can be formulated as a weighted combination of:

$${L}_{o} ( ω ) = \frac{1}{\vert O \vert} {\sum }_{i ∈ O} ( \vert S ( {p}_{i} , α ) \vert + ‖ {∇}_{{p}_{i}} S ( {p}_{i} , α ) - {n}_{i} ‖ ) \qquad ( 2 )$$

$${L}_{e} ( ω ) = \frac{1}{\vert F \vert} {\sum }_{i ∈ F} {( ‖ {∇}_{{p}_{i}} S ( {p}_{i} , α ) ‖ - 1 )}^{2} \qquad ( 3 )$$

$${L}_{l} ( ω ) = \frac{1}{\vert F \vert} {\sum }_{i ∈ F} BCE ( {l}_{i} , ϕ ( kS ( {p}_{i} , α ) ) ) , \qquad ( 4 )$$

where ϕ can represent the sigmoid function, O can represent surface samples from Y with normals n, and F can represent off surface samples with inside/outside labels l, including both uniformly sampled points within a bounding box and sampled points near the surface. The first term Lₒ can be utilized to encourage the surface samples to be on the zero-level-set and the SDF gradient to be equal to the given surface normals nᵢ. The Eikonal loss Lₑ can be derived from equation (1), where the SDF is differentiable everywhere with gradient norm 1. The SDF gradient ∇ₚᵢS(pᵢ, α) can, in some implementations, be obtained via backpropagation of the machine-learned implicit object representation model. In some implementations, a binary cross-entropy error (BCE) loss term Lᵢ over off-surface samples can be included, where k can control the sharpness of the decision boundary. As such, training losses can generally only require surface samples with normals and inside/outside labels for the off surface samples, which are conventionally much easier and faster to obtain than pre-computing the ground truth SDF values.

In some implementations, to avoid learning difficulties associated with implicit representation models (e.g., spectral bias, etc.), sample encoding can be utilized. As an example, each sample (e.g., latent code, etc.) can be encoded using Fourier mapping e₁=[sin(2π\tilde{p}ᵢ), cos(2π\tilde{p}ᵢ)]^{T}, where the samples can first be unposed using a root rigid transformation T₀⁻¹, and can be normalized into [0,1]³ with a shared bounding box B=[bₘᵢₙ, bₘₐₓ], as:

$${\tilde{p}}_{i} = \frac{{{T}_{0}^{- 1} ( θ , j ) [ {p}_{i} , 1 ]}^{T} - {b}_{min}}{{b}_{max} - {b}_{min}} . \qquad ( 5 )$$

It should be noted that the SDF can be defined with regards to original meshes Y, and therefore, sample normals are not necessarily unposed and/or scaled. Additionally, the loss gradients, in some implementations, can be derived with regards to pᵢ.

As another example, the object can be a human body comprising a plurality of object segments. For example, the human body object can include a head segment, a left hand segment, a right hand segment, and a remaining body segment. The machine-learned implicit object representation model can include four segment representation portions respectively associated with the four body segments. Each of the four segment representation portions can process the plurality of spatial query points and the latent code to respectively obtain implicit segment representations for the four object segments.

In some implementations, prior to processing the latent code and the spatial query points, one or more localized point sets can be determined based at least in part on the plurality of spatial query points. The one or more localized point sets can be respectively associated with the one or more object segments, and can each include a plurality of localized query points. For example, if the object is a human body that includes a foot segment, a localized point set can be determined that is respectively associated with the foot segment. This localized point set can include a plurality of localized query points that are localized in a three-dimensional space that includes the object segment.

As an example, the object can be a human body that includes a head segment. A localized point set can be determined for the head segment. The localized point set can include a plurality of localized query points that are localized for a three-dimensional volumetric space that includes the head segment (e.g., positioned about the surface of the head segment, etc.). To follow the previous example, for each of the plurality of spatial query points, an explicit skeleton corresponding to the human body object can be used to transform a spatial query point into a localized query point (e.g., normalized coordinate frames, etc.) such that localized query points {\tilde{p}^{j}} for the head segment can be determined.

Based at least in part on the one or more implicit segment representations, an implicit object representation and semantic data indicative of one or more surfaces of the object can be determined. As an example, the implicit object representation can be determined by concatenating each of the implicit segment representation(s) of the object segment(s). In some implementations, a fusing portion (e.g., a multi-layer perceptron, etc.) of the machine-learned implicit object representation model can be used to process the latent code and at least the one or more implicit segment representations to obtain the implicit object representation.

As a more particular example, the object can be a human body comprising a plurality of human body object segments (e.g., a head, hands, torso, etc.). A full-body implicit object representation S(p,α) (e.g., a full body signed distance function, etc.) can be composed (e.g., fused using a fusing layer of the model) from the implicit segment representations for the body object segments s^{j}=S^{j}(p,α), j∈{1, . . . , N} output by the segment representation portions of the machine-learned implicit object representation model.

As described previously, local sub-part segment representation portions can be trained with surface and off-surface samples within a bounding box B^{j} defined for each object segment(s) of the object. It should be noted that, if the object is a human body object, the neck and wrist joints (e.g., segments) of the object can be utilized as the root transformation for the head and hand segments respectively. Joint centers j can be obtained as a function given the neutral body shapes X̅(β_{b}). However, in some implementations, X̅ is not explicitly presented the implicit object representation. Therefore, a nonlinear joint regressor can be built from β_{b} to j, which can be trained and/or supervised using various sampling techniques (e.g., latent space sampling, etc.).

In some implementations, in order to fuse the implicit segment representations (e.g., localized segment signed distance functions, etc.) into an implicit object representation (e.g., full-object signed distance function, etc.), while at the same time preserving local detail, the last hidden layers of the segment representation portion(s) can be merged using an additional light-weight fusing portion (e.g., a multi-layer perceptron, etc.) of the machine-learned implicit object representation model (e.g., one or more multi-layer perceptron(s), etc.).

In addition, the semantic data indicative of one or more surfaces of the object can be determined based at least in part on the one or more implicit segment representations. In some implementations, the semantic data can be determined using the fusing portion of the machine-learned implicit object representation model. As mentioned previously, the implicit representation of object(s) corresponds naturally between shape instances. Many applications, such as pose tracking, texture mapping, semantic segmentation, and/or surface landmarks, largely benefit from such correspondences. As such, by determining the semantic data that indicates one or more surfaces of the object, the semantic data can later be utilized for mesh extraction from the implicit object representation and/or shading of a mesh representation of the object. As an example, the semantic data can include a plurality of semantic surface coordinates respectively associated with the plurality of spatial query points. Each of the plurality of semantic surface coordinates can indicate a surface of a three-dimensional mesh representation of the object nearest to a respective spatial query point.

To follow the previous example, given an arbitrary spatial query point on or near a surface Y (e.g., |S(pᵢ, α)|<σ, etc.), the semantic data can be determined based at least in part on the implicit segment representation(s) and/or the implicit object representation. The semantic data can, in some implementations, be defined as a 3D implicit function C(p,α)∈R³. Given a query point pᵢ, the 3D implicit function can return a correspondence point on a canonical mesh X(α₀) as

C(pᵢ,α)=wᵢv_{f}(α₀)=cᵢ,pᵢ*=wᵢv_{f}(α) (6)

where pᵢ* can represent the closest point of pᵢ in the mesh X(α), while f can represent the nearest face and w can represent the barycentric weights of the vertex coordinates v_{f}. In contrast to alternative semantic encodings, such as 2D texture coordinates, the semantics function C(p,α) can be smooth in the spatial domain without distortion and boundary discontinuities.

It should be noted that implicit representations (e.g., signed distance functions, etc.) generally return the shortest distance to the underlying implicit surface for a spatial point, whereas implicit semantics generally associate the query point to its closest surface neighbor. Hence, implicit semantics can generally be considered to be highly correlated to learning of implicit representation (e.g., learning to generate signed distance function(s), etc.). As such, the determination of both the implicit object representation and the semantic data—both S(p,α) and C(p,α)—can, in some implementations, be trained and/or performed using the fusing portion of the machine-learned implicit object representation model.

A loss function can be evaluated. The loss function can evaluate a difference between the implicit object representation and ground truth data associated with the object. The loss function can additionally evaluate a difference between the semantic data and the ground truth data. In some implementations, the ground truth data can be or otherwise include point cloud scanning data of the object. For example, a scanning device can be utilized (e.g., a LIDAR-type scanner, etc.) to generate a point cloud indicative of the surface(s) of an object. Alternatively, or additionally, in some implementations, the ground truth data can be or otherwise include a three-dimensional representation of the object (e.g., a three-dimensional polygonal mesh, etc.). One or more parameters of the machine-learned implicit object representation model can be adjusted based at least in part on the loss function.

As an example, to train the machine-learned implicit object representation model, a sample point pᵢ, defined for the object, can be transformed into the N localized point sets (e.g., local coordinate frames, etc.) using T₀^{j} and then can be passed to the segment representation portion(s) of the model (e.g., the single-part local multi-layer perceptrons, etc.). The fusing portion of the machine-learned implicit object representation model (e.g., a union SDF MLP, etc.) can then aggregate the shortest distance to the full object among the local distances of the implicit segment representations (e.g., signed distance function(s), etc.). The losses can be applied to the fusing portion as well, to ensure that the output satisfies the SDF property.

In some implementations, the spatial point encoding eᵢ requires all samples p to be inside the bounding box B, which may otherwise result in periodic SDFs due to sinusoidal encoding. However, a point sampled from the full object is likely to be outside of an object segments local bounding box B^{j}. Instead of clipping or projecting to the bounding box, the encoding of sample pᵢ can be augmented for segment representation portions S^{j} as eᵢ^{j}=[sin(2π\tilde{p}ᵢ^{j}), cos(2π\tilde{p}ᵢ^{j}), tanh(π(\tilde{p}ᵢ^{j}−0.5))]^{T}, where the last value can indicate the relative spatial location of the sample with regards to the bounding box. If a point pᵢ is outside the bounding box Bⱼ, the fusiung portion of the model can learn to ignore S^{j}(pᵢ^{j},α) for the final union output.

As another example, semantics can be trained fully supervised, using an L₁ loss for a collection of training sample points near and on the surface Y. Due to the correlation between tasks, the machine-learned implicit object representation model can predict both an implicit object representation (e.g., a signed distance, etc.), and semantic data, without expanding the capacity of the model. In some implementations, the machine-learned implicit object representation model can be trained using a batch-size of 16 containing 16 instances of a paired with 512 on surface, 256 near surface, and 256 uniform samples each. In some implementations, the loss function can be or otherwise include:

L=λₒ_{₁}Lₒ_{₁}+λₒ_{₂}Lₒ_{₂}+λₑLₑ+λₗλₗ

where Lₒ_{₁} can refer to the first part of Lₒ (distance) and Lₒ_{₂} to the second part (gradient direction), respectively. λₒ_{₁}=1, λₒ_{₂}=1, λₑ=0.1, and λₗ=0.5 can be chosen. Empirically, it is generally found that linearly increasing λₒ_{₁} to 50 over 100K iterations can lead to perceptually better results. In some implementations, the machine-learned implicit object representation model can be trained until convergence using various optimizer(s) (e.g., ADAM optimizer(s), etc.). As an example, the model can be trained using an ADAM optimizer with a learning rate of 0.2×10⁻³ exponentially decaying by a factor of 0.9 over 100K iterations.

In some implementations, the machine-learned implicit object representation model can include one or more neural networks. As an example, the machine-learned implicit object representation model can include a plurality of multi-layer perceptrons. For example, the fusing portion and each of the segment representation portion(s) of the model can be or otherwise include a multi-layer perceptron. In some implementations, a SoftPlus layer (e.g., rather than a ReLU layer, etc.) can be utilized for non-linear activation. For example,

$$SoftPlus ( x ) = \frac{1}{a} ln ( 1 + {e}^{ax} )$$

can be utilized with a=100.

Alternatively, or additionally, in some implementations, a swish function can be utilized rather than a ReLu function. As an example, the machine-learned implicit object representation model can include one 8-layer, 256-dimensional multi-layer perceptron (MLP) for a certain segment of the object (e.g., a body segment of a human body object, etc.), while three 4-layer, 256-dimensional MLPs can be used respectively for three other segments of the object (e.g., two hand segments and a head segment of a human body object, etc.). To follow the previous example, each of the MLPs can include a skip connection in the middle layer, and the last hidden layers of the MLPs can be aggregated in a 128-dimensional fully-connected layer with Swish nonlinear activation before the final network output.

To follow the previous example, in some implementations, the MLPs can modulate a signed distance field of the body object to match a scan of a body (e.g., point cloud data from a scan of a human body, etc.). For example, distance residuals can be determined from clothing, hair other apparel items, any divergence from a standard human template, etc. The output signed distance of a scan can be conditioned with both the distance and semantic fields of the body defined by ŝ=Ŝ(S(p,α))=Ŝ(s,c). More particularly, Ŝ can be trained separately for specific personalizations. As an example, an instance of Ŝ can be trained for a “dressed human” human body type personalization. As another example, an instance of Ŝ can be trained for a human body type with limb differences personalization (e.g., a personalization for amputees, etc.). In such fashion, the a separate instance of Ŝ can be represented separately from the underlying human body using different layer(s) of the machine-learned implicit object representation model.

In some implementations, the machine-learned implicit object representation model can include one or more fully-connected layers. As an example, the machine-learned implicit object representation model can be or otherwise include eight 512-dimensional fully-connected layers, and can additionally, or alternatively, include a skip connection at the 4th layer, concatenating the inputs with the hidden layer outputs. Alternatively, or additionally, in some implementations, to enable higher-order derivatives, the SoftPlus nonlinear activation can be utilized instead of ReLU as previously described.

In some implementations, if the machine-learned implicit object representation model includes a plurality of segment representation portions, the model can sometimes include a plurality of multi-layer perceptrons. As an example, the object can be a human body object, and can include a head segment, a body segment, and two hand segments. The machine-learned implicit object representation model can include a 8-layer 512-dimensional MLP for the body segment representation portion, two 4-layer 256-dimensional MLPs for the hand segment representation portions, and one 6-layer 256-dimensional MLP for the head segment representation portion. Each segment representation portion can, in some implementations, utilize a SoftPlus nonlinear activation, and can include a skip connection to the middle layer. In some implementations, the last hidden layers of the sub-networks can be aggregated in a 128-dimensional fully-connected layer with SoftPlus nonlinear activation, before the final network output is computed using a (last) fully-connected layer.

In some implementations, the machine-learned implicit object representation model can be or otherwise include a single segment representation portion that is trained to process the entirety of the object (e.g., an object with only one full-object segment, etc.).

In some implementations, various layer(s) of the machine-learned implicit object representation model can be frozen and/or unfrozen during training. As described in a previous example, reconstruction techniques (e.g., triangle soup surface reconstruction, etc.) can be generally performed by optimizing for α=(β_{b},β_{f},θ), such that all observed vertices \hat{v} are close to the implicit surface S(⋅,α)=0. However, in some implementations, after finding the α explaining the observation best, various component(s) of the machine-learned implicit object representation model can be frozen or unfrozen and further optimized to fully match the observation. For example, a last hidden layer of each of the segment representation portion(s) and/or the fusing portion of the model can be unfrozen, combining the part-network outputs. In some implementations, this can lead to training of the machine-learned implicit object representation model such that small changes to object poses still provide for plausible object shapes.

As an example, the machine-learned implicit object representation model trained using the previously described method can be trained using samples of a human object that is wearing non-tight fitting clothing. By overfitting to the observation as previously described, the semantics of the machine-learned implicit object representation model can be transferred to the observed shape, and can be re-posed while maintaining surface details. Additionally, in some implementations, the training of the machine-learned implicit object representation model as previously described can facilitate representation of human shapes without the use of templates, therefore facilitating the implicit representation of people with varying body shapes and/or disabilities (e.g., amputees, etc.).

In some implementations, a three-dimensional mesh representation of the object can be extracted from the implicit object representation. The three-dimensional mesh representation can include a plurality of polygons. As an example, the three-dimensional mesh representation can be extracted from the implicit object representation (e.g., one or more signed distance functions, etc.) using a mesh extraction technique (e.g., a marching cubes algorithm, etc.). In some implementations, after extracting the mesh, the plurality of polygons of the mesh can be shaded based at least in part on the semantic data.

As an example, using trained implicit semantics, textures and/or shading can be applied to arbitrary iso-surfaces (e.g., the polygons of the mesh representation, etc.) at level set |z|≤σ, reconstructed from the implicit object representation. During inference, an iso-surface mesh S(⋅,α)=z can be extracted using a mesh extraction technique (e.g., marching cubes, etc.). Then, for every generated vertex \tilde{v}ᵢ, the semantic of the vertex semantics can be queried and represented as C(\tilde{v}ᵢ,α). It should be noted that in some implementations, the queried correspondence point C(\tilde{v}ᵢ,α) may not correspond exactly on the canonical surface of the mesh, and therefore, the correspondence point can be projected onto X(α₀). The UV texture coordinates can be interpolated and assigned to \tilde{v}ᵢ. Similarly, in some implementations, segmentation labels can be assigned to each vertex \tilde{v}ᵢ based on the semantics C(\tilde{v}ᵢ,α) of the vertex. As an example, the semantic data can be utilized to apply skin shading to a three-dimensional mesh representation of a human body object. As another example, the semantic data can be utilized to apply clothing and/or shading to clothing of a three-dimensional mesh representation of a human body object.

In some implementations, the implicit object representation can be rendered using sphere tracing. More particularly, a save step length can be calculated based on the current minimal distance to any point on the surface of the object (e.g., an SDF value at the current location, etc.). As an example, for inexact SDFs, a damped step can be taken to reduce the likelihood of overshooting. By utilizing sphere tracing, depth maps, normal maps, and/or semantics can be rendered (e.g., as each pixel can include the last queried value of its corresponding camera array, etc.).

As an example, differentiable approximate sphere tracing can be implemented by taking a fixed number of steps. For example, a fixed number of save steps T=15 can be taken into the SDF in the direction of each camera ray. At each final point P_{T} of each camera ray, the signed distance can be queried to generate the binarized pixel as represented by:

$$b = \frac{1}{η {S ( pT , α )}^{2} + 1}$$

where η can equal 5000, and where b can be differentiable by α. A standard silhouette overlap loss can be formulated alongside a sparse 2D landmark loss, and both losses can be utilized to fit the implicit object representation to image evidence.

Systems and methods of the present disclosure provide a number of technical effects and benefits. As one example technical effect and benefit, generation of explicit object representations (e.g., three-dimensional polygonal mesh, etc.) generally relies on standardized templates, making representation of non-standard object types prohibitively difficult (e.g., amputees, disabled peoples, etc.). By generating an implicit representation that can be converted to an explicit representation, systems and methods of the present disclosure retain the benefits of explicit representation while obviating the need for standardized templates, allowing for representation of non-standard objects and body types. As another example technical effect and benefit, generation of explicit object representations are generally bound to specific resolutions, making scaling and/or resizing of the representation computationally costly and inefficient. Unlike explicit representations, implicit representations of three-dimensional objects avoid the difficulties of non-standard object representation and scaling. By training and utilizing machine-learned models for implicit object representation, the computational costs associated with resizing and/or scaling explicit representations (e.g., computation cycles, memory, processing resources, power, etc.) can be significantly reduced.

With reference now to the Figures, example embodiments of the present disclosure will be discussed in further detail.

### Example Devices and Systems

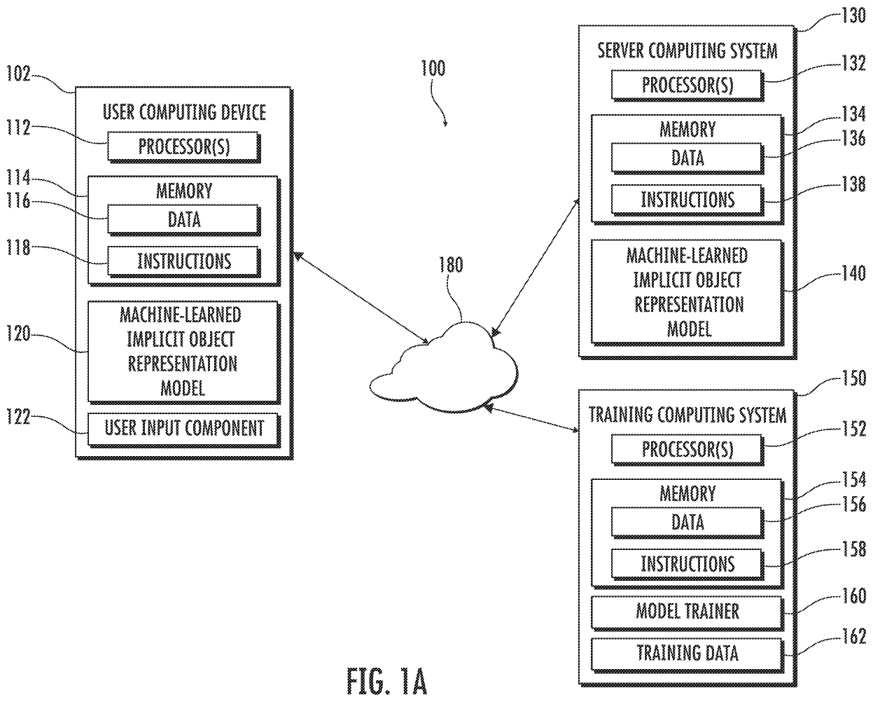

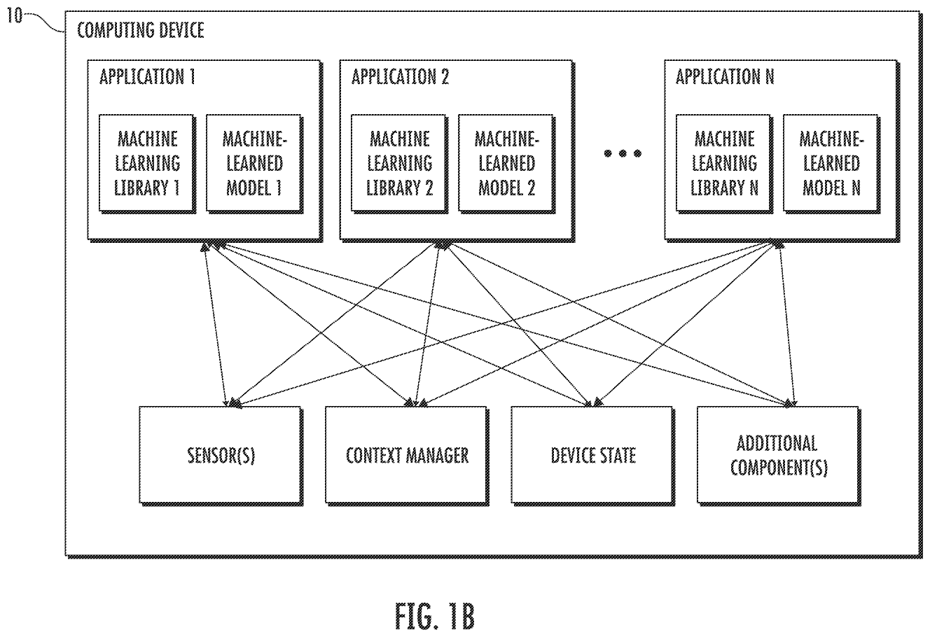

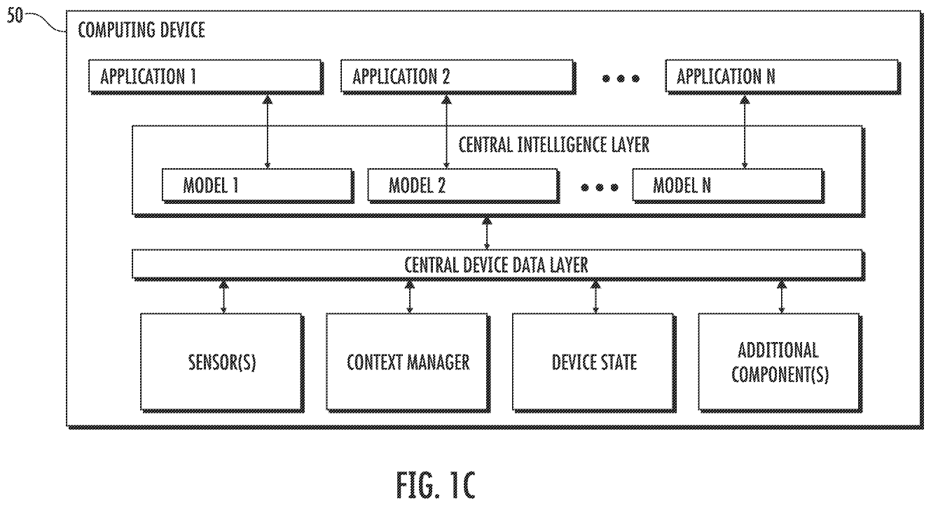

FIG. 1A depicts a block diagram of an example computing system 100 that performs training and utilization of machine-learned implicit object representation models according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

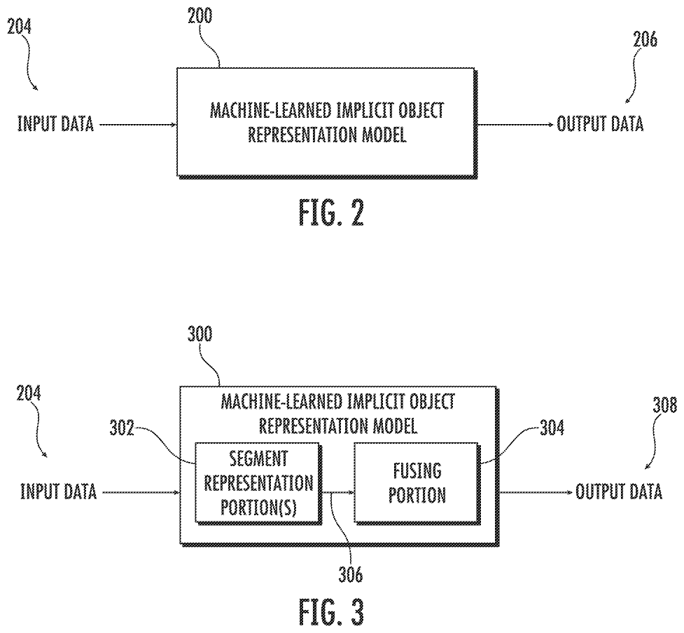

In some implementations, the user computing device 102 can store or include one or more machine-learned implicit object representation models 120. For example, the machine-learned implicit object representation models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned implicit object representation models 120 are discussed with reference to FIGS. 2-5.

In some implementations, the one or more machine-learned implicit object representation models 120 can be received from the server computing system 130 over network 180, stored in the user computing device memory 114, and then used or otherwise implemented by the one or more processors 112. In some implementations, the user computing device 102 can implement multiple parallel instances of a single machine-learned implicit object representation model 120 (e.g., to perform parallel implicit object representation generation across multiple instances of the machine-learned implicit object representation model).

More particularly, the user computing device 102 can obtain a latent code that describes an object (e.g., a shape and pose of a human body, etc.). The object described by the latent code can include one or more object segments. For example, if the object is a human body, the object can include arm, torso, leg, and foot segments. The user computing device 102 can determine a plurality of spatial query points within a three dimensional space that includes the object (e.g., arbitrary points within a volumetric space that includes the object, etc.). Each of the spatial query points can be processed alongside the latent code using one or more segment representation portions of the machine-learned implicit object representation model 120 to obtain one or more implicit segment representations for the object segment(s) (e.g., a head representation and a torso representation for head and torso segments of a human body object, etc.). Based at least in part on the implicit segment representation(s), the user computing device 102 can determine an implicit object representation and semantic data associated with the object. The semantic data can be indicative of one or more surfaces of the object (e.g., corresponding polygons of a mesh representation, etc.). In some implementations, the user computing device 102 can extract a three-dimensional mesh representation from the implicit representation (e.g., using a marching cubes algorithm, etc.), and can be shaded or otherwise modified based on the semantic data.

Additionally or alternatively, one or more machine-learned implicit object representation models 140 can be included in or otherwise stored and implemented by the server computing system 130 that communicates with the user computing device 102 according to a client-server relationship. For example, the machine-learned implicit object representation models 140 can be implemented by the server computing system 140 as a portion of a web service (e.g., a implicit object representation service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned implicit object representation models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIGS. 2-5.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned implicit object representation models 120 and/or 140 based on a set of training data 162. The training data 162 can include, for example, ground truth data associated with one or more latent codes. In some implementations, the ground truth data can be or otherwise include point cloud scanning data of the object. For example, a scanning device can be utilized (e.g., a LIDAR-type scanner, etc.) to generate a point cloud indicative of the surface(s) of an object. Alternatively, or additionally, in some implementations, the ground truth data can be or otherwise include a three-dimensional representation of the object (e.g., a three-dimensional polygonal mesh, etc.). One or more parameters of the machine-learned implicit object representation model 120 and/or 140 can be adjusted based at least in part on the loss function that evaluates the ground truth data included in the training data 162.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 1A illustrates one example computing system that can be used to implement the present disclosure. Other computing systems can be used as well. For example, in some implementations, the user computing device 102 can include the model trainer 160 and the training data 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that generates implicit object representations according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs training of machine-learned implicit object representation models according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

### Example Model Arrangements

FIG. 2 depicts a block diagram of an example machine-learned implicit object representation model 200 according to example embodiments of the present disclosure. In some implementations, the machine-learned implicit object representation model 200 is trained to receive a set of input data 204 descriptive of a latent code that describes at least the shape of an object and, as a result of receipt of the input data 204, provide output data 206 descriptive of an implicit representation of the object.

More particularly, the input data 204 can describe a latent code that describes an object (e.g., a shape and pose of a human body, etc.). The object described by the latent code 204 can include one or more object segments. For example, if the object is a human body, the object can include arm, torso, leg, and foot segments. A plurality of spatial query points can be determined within a three dimensional space that includes the object (e.g., arbitrary points within a volumetric space that includes the object, etc.). Each of the spatial query points can be processed alongside the latent code 204 using one or more segment representation portions of a machine-learned implicit object representation model 200 to obtain one or more implicit segment representations for the object segment(s) (e.g., a head representation and a torso representation for head and torso segments of a human body object, etc.). The machine-learned implicit object representation model 200 can process the implicit segment representations to output the output data 206. The output data 206 can include an implicit object representation of the object and semantic data associated with the object.

FIG. 3 depicts a block diagram of an example machine-learned implicit object representation model 300 according to example embodiments of the present disclosure. The machine-learned implicit object representation model 300 is similar to machine-learned implicit object representation model 200 of FIG. 2 except that machine-learned implicit object representation model 300 further includes segment representation portion(s) 302 and fusing portion 304.

More particularly, the input data 204 can describe or otherwise include the latent code as described with regards to FIG. 2. Additionally, the input data 204 can include or otherwise describe a plurality of spatial query points. The latent code and each of the plurality of spatial query points of the input data 204 can be provided to the machine-learned object representation model 300. The latent code and each of the plurality of spatial query points of the input data 204 can be processed using the segment representation portion(s) 302 of the machine-learned implicit object representation model 300 to obtain one or more respective implicit segment representations 306 (e.g., one or more signed distance function(s), etc.) for the one or more object segments of the object described by the latent code 204. The fusing portion 304 of the machine-learned implicit object representation model 300 can be used to process the one or more implicit segment representations 306 to obtain the output data 308. The output data 308 can include an implicit object representation and semantic data that describes one or more surfaces of the object described by the latent code 204.

In such fashion, the segment representation portion(s) 302 can process the latent code and spatial query points described by the input data 204 to obtain implicit segment representation(s) for the segment(s) of the object. The implicit segment representation(s) and, in some implementations, the latent code 204, can be processed with the fusing portion 304 of the model 300 to obtain the output data 308.

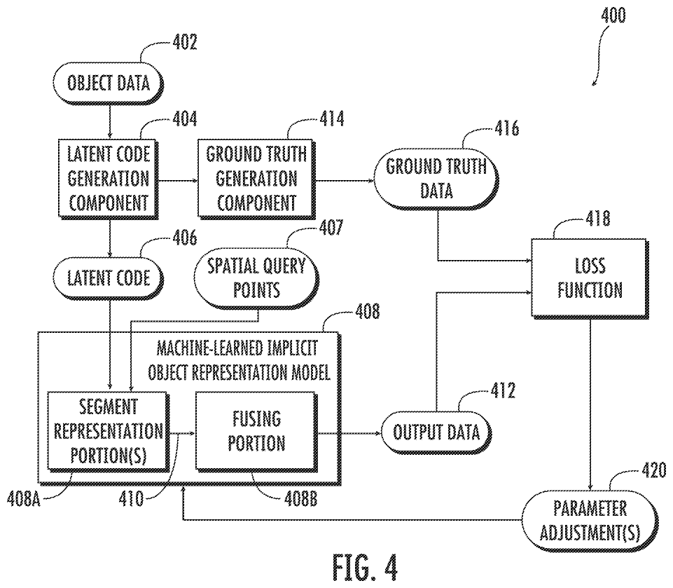

FIG. 4 depicts a data flow diagram 400 for training an example machine-learned implicit object representation model according to example embodiments of the present disclosure. More particularly, object data 402 can depict, include, or otherwise describe an object that includes one or more object segments. As an example, object data 402 can be two-dimensional image data that depicts an object. As another example, object data 402 can be three-dimensional image data that depicts an object (e.g., point cloud data, three-dimensional mesh data, etc.). As yet another example, the object data 402 can be an encoding that is associated with an object.

The object data 402 can be processed using a latent code generation component 404 to obtain latent code 406. In some implementations, the latent code generation component 404 can be a machine-learned model. For example, the latent code generation component 404 can be a machine-learned model trained to process two-dimensional image data and generate a latent encoding code 406 that is descriptive of the object. The latent code 406 can describe at least a shape of an object that includes one or more object segments. As an example, the latent code 406 can include a plurality of shape parameters that collectively describe the shape of the object, and a plurality of pose parameters that collectively describe the pose of the object. The object can be any physical object as described previously in the specification. Alternatively, in some implementations, the latent code generation component 404 can be, include, or otherwise utilize a non-machine-learned encoding technique to generate the latent code 406 from the object data 402. As an example, the latent code generation component 404 may be or otherwise include a processing device configured to encode the object data 402 using a conventional encoding scheme to obtain the latent code 406.

Additionally, a plurality of spatial query points 407 can be determined. The spatial query points 407 can be determined within a three-dimensional space that includes the object described by the latent code 406. As an example, a spatial query point 407 can exist in a three-dimensional space that includes a representation of the object (e.g., a volumetric space that includes a three-dimensional representation of the object, etc.). More particularly, the spatial query point 407 can be located outside of the volume of the representation of the object, and can be located a certain distance away from a surface of the object. The plurality of spatial query points 407 can be arbitrarily determined at various distances from the surface(s) of the representation of the object. For example, the plurality of spatial query points 407 may be or otherwise appear as plurality of points 407 external to the object, and scattered in three dimensions at various distances from the object.

The latent code 406 can be processed alongside the spatial query points 407 with a machine-learned implicit object representation model 408. More particularly, the latent code 406 and each of the spatial query points 407 can be processed with one or more segment representation portions 408A (e.g., one or more respective multi-layer perceptrons, etc.) of the machine-learned implicit object representation model 408 (e.g., a plurality of multi-layer perceptrons, etc.). The segment representation portion(s) 408A of the machine-learned implicit object representation model 408 can process the latent code 406 and the spatial query points 407 to obtain one or more respective implicit object representations 410 for the one or more segments of the object described by the latent code 406. As an example, the object can be a human body object that includes four body segments. The machine-learned implicit object representation model 408 can include four segment representation portions 408A respectively associated with the four body segments. The four segment representation portions can process the latent code 406 and each of the spatial query points 407 to obtain an implicit segment representation 410 for each of the four body segments.

The fusing portion 408B of the machine-learned implicit object representation model 408 can process the implicit segment representation(s) 410 to obtain output data 412. The output data 412 can be or otherwise include an implicit object representation of the object and semantic data indicative of one or more surfaces of the object. The semantic data of the output data 412 indicative of one or more surfaces of the object can be determined based at least in part on the one or more implicit segment representations 410. Additionally, the semantic data of the output data 412 can indicate one or more surfaces of the object. More particularly, the semantic data of the output data 412 can later be utilized for mesh extraction from the implicit object representation of the output data 412 and/or shading of a mesh representation of the object. As an example, the semantic data of the output data 412 can include a plurality of semantic surface coordinates respectively associated with the plurality of spatial query points 407. Each of the plurality of semantic surface coordinates can indicate a surface of a three-dimensional mesh representation of the object nearest to a respective spatial query point 407.

Alongside processing by the machine-learned implicit object representation model 408, the latent code 406 can also be processed using a ground truth generation component 414. In some implementations, the ground truth generation component 414 may be or otherwise include a machine-learned model. As an example, the ground truth generation component 414 may be a machine-learned model trained to process the latent code 406 to generate an explicit three-dimensional mesh representation of the object described by the object data 402 (e.g., ground truth data 416, etc.). Alternatively, in some implementations, the ground truth generation component 414 can be a non-machine-learned component configured to generate ground truth data descriptive of ground truth data 416 associated with the object described by the latent code 406 (e.g., a conventional mesh generation technique, etc.).

In some implementations, both the latent code generation component 404 and the ground truth generation component 414 can be or otherwise include respective portions of an overall machine-learned model. As an example, a machine-learned explicit object representation model can be configured to process object data 402 using a portion of the model (e.g., using the latent code generation component 404, etc.) to obtain latent code 406, and further process the latent code 406 using a second portion of the model (e.g., ground truth generation component 414, etc.) to obtain an explicit mesh representation of the object described in the object data 402 (e.g., ground truth data 416, etc.). In such fashion, a pre-trained machine-learned model trained to generate explicit representations of an object can be utilized at least in part to train the machine-learned implicit object representation 408, therefore increasing the accuracy of the implicit representation of the object (e.g., output data 412) and optimizing the implicit representation for later extraction of an explicit object representation (e.g., using a marching cubes algorithm, etc.).

A loss function 418 can evaluate a difference between the output data 412 and the ground truth data 416. More particularly, the loss function 418 can evaluate a difference between the implicit object representation of the object data 412 and the ground truth data 416 and a difference between the semantic data of the object data 412 and the ground truth data 416. Based on these evaluations, parameter adjustments 420 can be determined and applied to the machine-learned implicit object representation model 408 using one or more optimization techniques (e.g., gradient descent, ADAM optimizer(s), etc.). In such fashion, the machine-learned implicit object representation model 408 can be optimized to more accurately and efficiently generate implicit object representation(s) and semantic data for objects.

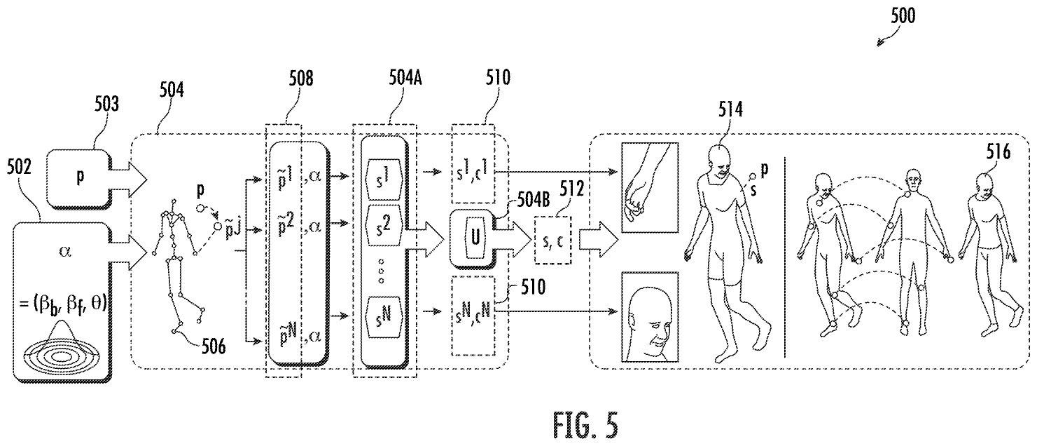

FIG. 5 depicts a data flow diagram 500 for utilization of a machine-learned implicit object representation model according to example embodiments of the present disclosure. More particularly, a latent code 502 descriptive of a shape of an object can be obtained. The latent code 502 can include a plurality of shape parameters indicative of a shape of an object (e.g., clothing, a human body, an animal body, a vehicle, furniture, etc.) and a plurality of pose parameters indicative of a pose of the object. Additionally, in some implementations the latent code 502 can include a plurality of facial expression parameters indicative of a facial expression of a human body object. Each of the kinematic pose parameters θ can represent a set of joint transformations T(θ,j)∈R^{J×3×4} from the neutral to a posed state, where j∈R^{J×3} can represent the joint centers that are dependent on the neutral body shape. The shape parameters of the body included in the latent code 502 can be represented using a nonlinear embedding β_{b}∈R¹⁶. Similarly, the facial expression parameters can indicate the facial expression of the human body as nonlinear latent code β_{f}∈R²⁰, giving an overall representation of the latent code 502 as a=(β_{b},β_{f},θ). Additionally, a spatial query point 503 can be obtained alongside the latent code 502.

The latent code 502 and the spatial query point 503 can be processed to obtain J joint centers of a posed skeleton object 506. In some implementations, the shape parameters can be processed using a portion of a machine-learned implicit object representation model 504 to obtain the joint centers. As an example, the shape parameters of the latent code 502 can be processed using a nonlinear joint regression portion of the machine-learned implicit object representation model 504 (e.g., a multi-layer perceptron, etc.) to obtain the joint centers of the posed skeleton object 506.

A plurality of localized point sets 508 can be determined based at least in part on the spatial query point 503 and the posed skeleton object 506. The plurality of localized point sets 508 can be respectively associated with a plurality of object segments of the object, and can each include a plurality of localized query points. For example, if the object is a human body that includes a foot segment, a localized point set 508 can be determined that is respectively associated with the foot segment. This localized point set of the plurality of localized point sets 508 can include a plurality of localized query points that are localized in a three-dimensional space that includes the segment of the object 506.

The plurality of localized point sets 508 can be processed alongside the latent code 502 with a respective plurality of segment representation portions 504A of the machine-learned implicit object representation model 504 to obtain a respective plurality of implicit segment representation 510. Additionally, in some implementations, the implicit segment representations 510 can include segment semantic data descriptive of one or more surfaces of the segment. Based on the implicit segment representations 510, output data 512 can be determined. For example, the fusing portion 504B of the machine-learned implicit object representation model can process the implicit segment representations 510 to obtain the output data 512. The output data 512 can include an implicit object representation and semantic data descriptive of one or more surfaces of the object. The implicit object representation of the output data 512 can implicitly represent the object described by the latent code 502. As an example, a full-body implicit object representation S(p,α) of the output data 512 (e.g., a full body signed distance function, etc.) can be composed (e.g., fused using the fusing portion 504B of the model 504) from the implicit segment representations 510 for the body object segments s^{j}=S^{j}(p,α), j∈({1, . . . , N} output by the segment representation portions 504A of the machine-learned implicit object representation model 504.

The semantic data of the output data 512 can describe one or more surfaces of the object described by the latent code 502. As an example, the semantic data of output data 512 can include a plurality of semantic surface coordinates respectively associated with the plurality of spatial query points 508. Each of the plurality of semantic surface coordinates of output data 512 can indicate a surface of a three-dimensional mesh representation of the object nearest to a respective spatial query point 510. For example, given an arbitrary spatial query point 508 on or near a surface Y (e.g., |S(βᵢ,α)|<σ, etc.), the semantic data of the output data 512 can be determined based at least in part on the implicit segment representations 510 and/or the implicit object representation of the output data 512. The semantic data of the output data 512 can, in some implementations, be defined as a 3D implicit function C(p,α)∈R³. Given a query point pᵢ, the 3D implicit function can return a correspondence point on a canonical mesh X(α₀) as

C(pᵢ,α)=wᵢv_{f}(α₀)=cᵢ,pᵢ*32 wᵢv_{f}((α) (6)

where pᵢ* can represent the closest point of pᵢ in the mesh X(α), while f can represent the nearest face and w can represent the barycentric weights of the vertex coordinates v_{f}. In contrast to alternative semantic encodings, such as 2D texture coordinates, the semantics function C(p,α) of the output data 512 can be smooth in the spatial domain without distortion and boundary discontinuities.

In some implementations, the output data can be obtained by processing the plurality of implicit segment representations with a fusing portion 504B of the machine-learned implicit object representation model 504. As an example, the last hidden layers of the segment representation portion(s) 504A can be merged using an additional light-weight fusing portion 504C (e.g., a multi-layer perceptron, etc.) of the machine-learned implicit object representation model 504 (e.g., one or more multi-layer perceptron(s), etc.).

In some implementations, a three-dimensional mesh representation 514 of the object can be extracted from the implicit object representation of the output data 512. The three-dimensional mesh representation 514 can include a plurality of polygons. As an example, the three-dimensional mesh representation 514 can be extracted from the implicit object representation of the output data 512 (e.g., one or more signed distance functions, etc.) using a mesh extraction technique (e.g., a marching cubes algorithm, etc.). In some implementations, after extracting the mesh, the plurality of polygons of the mesh can be shaded based at least in part on the semantic data of the output data 512 to obtain a shaded explicit representation 516.

In some implementations, the body surface 514 and/or textured surface 516 can be rendered using sphere tracing. More particularly, a save step length can be calculated based on the current minimal distance to any point on the surface of the object (e.g., an SDF value at the current location, etc.). As an example, for inexact SDFs, a damped step can be taken to reduce the likelihood of overshooting. By utilizing sphere tracing, depth maps, normal maps, and/or semantics can be rendered (e.g., as each pixel can include the last queried value of its corresponding camera array, etc.).

As an example, differentiable approximate sphere tracing can be implemented by taking a fixed number of steps. For example, a fixed number of save steps T=15 can be taken into the SDF in the direction of each camera ray. At each final point P_{T} of each camera ray, the signed distance can be queried to generate the binarized pixel as represented by:

$$b = \frac{1}{η {S ( pT , α )}^{2} + 1}$$

where η can equal 5000, and where b can be differentiable by α. A standard silhouette overlap loss can be formulated alongside a sparse 2D landmark loss, and both losses can be utilized to fit the implicit object representation to image evidence.

### Example Methods

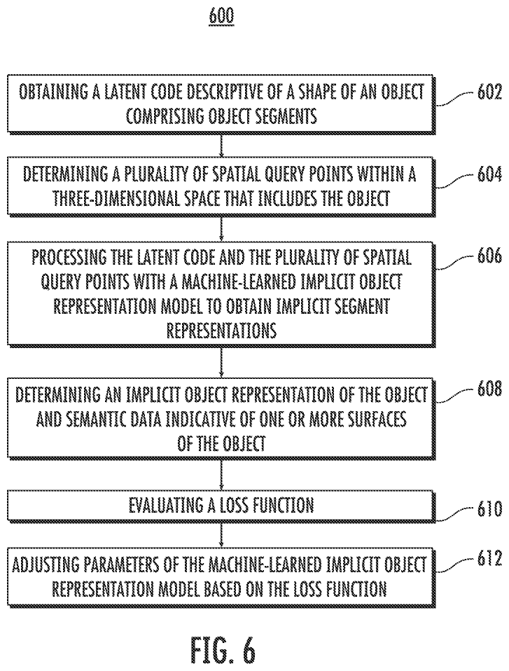

FIG. 6 depicts a flow chart diagram of an example method 600 to perform implicit object representation according to example embodiments of the present disclosure. Although FIG. 6 depicts steps performed in a particular order for purposes of illustration and discussion, the methods of the present disclosure are not limited to the particularly illustrated order or arrangement. The various steps of the method 600 can be omitted, rearranged, combined, and/or adapted in various ways without deviating from the scope of the present disclosure.

At 602, a computing system can obtain a latent code descriptive of a shape of an object comprising object segments. More particularly, the computing system can obtain a latent encoding of an object depiction. The latent code can describe a shape of an object (e.g., clothing, a human body, an animal body, a vehicle, furniture, etc.). In some implementations, the latent code can include a plurality of shape parameters indicative of the shape of the object and/or a plurality of pose parameters indicative of a pose of the object. a include pose of the object. The object can include one or more object segments. For example, if the object is a human body, the object can include various segment(s) of the human body (e.g., one or more arm segments, one or more foot segments, one or more hand segments, one or more leg segments, a body segment including a portion of the human body, a full-body segment including the entire human body, a face segment, a head segment, a torso segment, etc.). As an example, the object can be a human body that includes a number of human body segments (e.g., arms, legs, torso, head, face, etc.). The latent code can be or otherwise include shape and/or pose kinematics θ∈R¹²⁴. Each kinematic θ can represent a set of joint transformations T(θ,j)∈R^{J×3×4} from the neutral to a posed state, where j∈R^{J×3} can represent the joint centers that are dependent on the neutral body shape. The shape of the body included in the latent code can be represented using a nonlinear embedding β_{b}∈R¹⁶. In addition to skeleton articulation, the latent code can, in some implementations, include or otherwise represent a facial expression of the human body as nonlinear latent code β_{f}∈R²⁰, giving an overall latent code represented as α=(β_{b},β_{f},θ).

In some implementations, the latent code can be generated based at least in part on two-dimensional image data that depicts the object. As an example, the two-dimensional image data can be processed using a machine-learned model configured to generate a latent representation of the shape and/or pose of the object. Alternatively, or additionally, in some implementations, the latent code can be generated based on three-dimensional image data that depicts the object.

At 604, the computing system can determine a plurality of spatial query points. More particularly, the computing system can determine a plurality of spatial query points within a three-dimensional space that includes the object. As an example, a spatial query point can exist in a three-dimensional space that includes a representation of the object (e.g., a volumetric space that includes a three-dimensional representation of the object, etc.). More particularly, the spatial query point can be located outside of the volume of the representation of the object, and can be located a certain distance away from a surface of the object. The plurality of spatial query points can be arbitrarily determined at various distances from the surface(s) of the representation of the object. For example, the plurality of spatial query points may be or otherwise appear as plurality of points external to the object, and scattered in three dimensions at various distances from the object.

At 606, the computing system can process the latent code and the plurality of spatial query points with a machine-learned implicit object representation model to obtain implicit segment representations. More particularly, alongside the latent code, the computing system can process each of the plurality of spatial query points using one or more segment representation portions (e.g., one or more multi-layer perceptron(s), etc.) of the machine-learned implicit object representation model (e.g., one or more multi-layer perceptron(s), etc.) to obtain one or more respective implicit segment representations (e.g., one or more signed distance function(s), etc.) for the one or more object segments. As an example, the object can be a human body object that includes a torso segment and a head segment. The machine-learned implicit object representation model can include two segment representation portions: a first segment representation portion associated with the torso segment and a second segment representation portion associated with the head segment. The first segment representation portion can process the latent code and each of the spatial query points to obtain an implicit segment representation for the torso segment. The second segment representation portion can process the latent code and each of the spatial query points to obtain an implicit segment representation (e.g., a plurality of signed distance functions, etc.) for the head segment. As such, a respective segment representation portion for each segment of an object can be included in the machine-learned implicit object representation model.

In some implementations, the implicit segment representation portion(s) obtained with the machine-learned implicit object representation model can be or otherwise include signed distance function(s). As an example, given a latent representation a descriptive of the shape and pose of a human body, the posed body can be modeled as the zero iso-surface decision boundaries of Signed Distance Functions (SDFs) given by the machine-learned implicit object representation model (e.g., deep feed-forward neural network(s), multi-layer perceptron(s), etc.). A signed distance S(p,α)∈R can be or otherwise represent a continuous function that given an arbitrary spatial point p∈R³, outputs the shortest distance to the surface defined by a, where the sign can indicate the inside (e.g., a negative value) or outside (e.g., a positive value) with regards to the surface of the object. The posed human body surface can be implicitly provided by S(⋅,α)=0. As such, the implicit representation of the object can be estimated as a signed distance value s=S(p,α) for each arbitrary spatial point p.

As another example, the object can be a human body including a single body segment, and the machine-learned implicit object representation model can include a single segment representation portion associated with the body segment. Given the latent code descriptive of the shape of the body α=(β_{b},β_{f},θ), an implicit representation S(p,α) can be obtained that approximates the shortest signed distance to Y for any query point p. It should be noted that, in some implementations, Y can be or otherwise include arbitrary meshes, such as raw human scans, mesh registrations, or explicit mesh samplings. The zero iso-surface S(⋅,α)=0 is sought to preserve all geometric detail in Y, including body shapes and poses, hand articulation, and facial expressions.

To follow the previous example, the machine-learned implicit object representation model can, in some implementations, be or otherwise include one global neural network that is configured to determine the implicit representation S(p,α) for a given latent code α and a spatial point p. More particularly, the machine-learned implicit object representation model can be or otherwise include one or more MLP network(s) S(p,α;ω) configured to to output a solution to the Eikonal equation:

∥∇ₚS(p,α;ω)∥=1, (1)

where S can represent a signed distance function that vanishes at the surface Y with gradients equal to surface normals. For example, the total loss can be formulated as a weighted combination of:

$${L}_{o} ( ω ) = \frac{1}{\vert O \vert} {\sum }_{i ∈ O} ( \vert S ( {p}_{i} , α ) \vert + ‖ {∇}_{{p}_{i}} S ( {p}_{i} , α ) - {n}_{i} ‖ ) \qquad ( 2 )$$

$${L}_{e} ( ω ) = \frac{1}{\vert F \vert} {\sum }_{i ∈ F} {( ‖ {∇}_{{p}_{i}} S ( {p}_{i} , α ) ‖ - 1 )}^{2} \qquad ( 3 )$$

$${L}_{l} ( ω ) = \frac{1}{\vert F \vert} {\sum }_{i ∈ F} BCE ( {l}_{i} , ϕ ( kS ( {p}_{i} , α ) ) ) , \qquad ( 4 )$$

where ϕ can represent the sigmoid function, O can represent surface samples from Y with normals n, and F can represent off surface samples with inside/outside labels l, including both uniformly sampled points within a bounding box and sampled points near the surface. The first term Lₒ can be utilized to encourage the surface samples to be on the zero-level-set and the SDF gradient to be equal to the given surface normals nᵢ. The Eikonal loss Lₑ can be derived from equation (1), where the SDF is differentiable everywhere with gradient norm 1. The SDF gradient ∇ₚᵢS(pᵢ,α) can, in some implementations, be obtained via backpropagation of the machine-learned implicit object representation model. In some implementations, a binary cross-entropy error (BCE) loss term Lₗ over off-surface samples can be included, where k can control the sharpness of the decision boundary. As such, training losses can generally only require surface samples with normals and inside/outside labels for the off surface samples, which are conventionally much easier and faster to obtain than pre-computing the ground truth SDF values.

In some implementations, to avoid learning difficulties associated with implicit representation models (e.g., spectral bias, etc.), sample encoding can be utilized. As an example, each sample (e.g., latent code, etc.) can be encoded using Fourier mapping eᵢ=[sin(2π\tilde{p}ᵢ), cos(2π\tilde{p}ᵢ)]^{T}, where the samples can first be unposed using a root rigid transformation T₀⁻¹, and can be normalized into [0,1]³ with a shared bounding box B=[bₘᵢₙ, bₘₐₓ], as:

$${\tilde{p}}_{i} = \frac{{{T}_{0}^{- 1} ( θ , j ) [ {p}_{i} , 1 ]}^{T} - {b}_{min}}{{b}_{max} - {b}_{min}} . \qquad ( 5 )$$

It should be noted that the SDF can be defined with regards to original meshes Y, and therefore, sample normals are not necessarily unposed and/or scaled. Additionally, the loss gradients, in some implementations, can be derived with regards to pᵢ.

As another example, the object can be a human body comprising a plurality of object segments. For example, the human body object can include a head segment, a left hand segment, a right hand segment, and a remaining body segment. The machine-learned implicit object representation model can include four segment representation portions respectively associated with the four body segments. Each of the four segment representation portions can process the plurality of spatial query points and the latent code to respectively obtain implicit segment representations for the four object segments.

In some implementations, prior to processing the latent code and the spatial query points, one or more localized point sets can be determined based at least in part on the plurality of spatial query points. The one or more localized point sets can be respectively associated with the one or more object segments, and can each include a plurality of localized query points. For example, if the object is a human body that includes a foot segment, a localized point set can be determined that is respectively associated with the foot segment. This localized point set can include a plurality of localized query points that are localized in a three-dimensional space that includes the object segment.

As an example, the object can be a human body that includes a head segment. A localized point set can be determined for the head segment. The localized point set can include a plurality of localized query points that are localized for a three-dimensional volumetric space that includes the head segment (e.g., positioned about the surface of the head segment, etc.). To follow the previous example, for each of the plurality of spatial query points, an explicit skeleton corresponding to the human body object can be used to transform a spatial query point into a localized query point (e.g., normalized coordinate frames, etc.) such that localized query points {\tilde{p}^{j}} for the head segment can be determined.

At 608, the computing system can determine an implicit object representation of the object and semantic data indicative of one or more surfaces of the object. More particularly, based at least in part on the one or more implicit segment representations, the computing system can determine an implicit object representation and semantic data indicative of one or more surfaces of the object. As an example, the implicit object representation can be determined by concatenating each of the implicit segment representation(s) of the object segment(s). In some implementations, a fusing portion (e.g., a multi-layer perceptron, etc.) of the machine-learned implicit object representation model can be used to process the latent code and at least the one or more implicit segment representations to obtain the implicit object representation.

As a more particular example, the object can be a human body comprising a plurality of human body object segments (e.g., a head, hands, torso, etc.). A full-body implicit object representation S(p,α) (e.g., a full body signed distance function, etc.) can be composed (e.g., fused using a fusing layer of the model) from the implicit segment representations for the body object segments s^{j}=S^{j}(p,α), j∈{1, . . . , N} output by the segment representation portions of the machine-learned implicit object representation model.

As described previously, local sub-part segment representation portions can be trained with surface and off-surface samples within a bounding box B^{j} defined for each object segment(s) of the object. It should be noted that, if the object is a human body object, the neck and wrist joints (e.g., segments) of the object can be utilized as the root transformation for the head and hand segments respectively. Joint centers j can be obtained as a function given the neutral body shapes X̅(β_{b}). However, in some implementations, X is not explicitly presented the implicit object representation. Therefore, a nonlinear joint regressor can be built from β_{b} to j, which can be trained and/or supervised using various sampling techniques (e.g., latent space sampling, etc.).

In some implementations, in order to fuse the implicit segment representations (e.g., localized segment signed distance functions, etc.) into an implicit object representation (e.g., full-object signed distance function, etc.), while at the same time preserving local detail, the last hidden layers of the segment representation portion(s) can be merged using an additional light-weight fusing portion (e.g., a multi-layer perceptron, etc.) of the machine-learned implicit object representation model (e.g., one or more multi-layer perceptron(s), etc.).

In addition, the semantic data indicative of one or more surfaces of the object can be determined based at least in part on the one or more implicit segment representations. In some implementations, the semantic data can be determined using the fusing portion of the machine-learned implicit object representation model. As mentioned previously, the implicit representation of object(s) corresponds naturally between shape instances. Many applications, such as pose tracking, texture mapping, semantic segmentation, and/or surface landmarks, largely benefit from such correspondences. As such, by determining the semantic data that indicates one or more surfaces of the object, the semantic data can later be utilized for mesh extraction from the implicit object representation and/or shading of a mesh representation of the object. As an example, the semantic data can include a plurality of semantic surface coordinates respectively associated with the plurality of spatial query points. Each of the plurality of semantic surface coordinates can indicate a surface of a three-dimensional mesh representation of the object nearest to a respective spatial query point.

To follow the previous example, given an arbitrary spatial query point on or near a surface Y (e.g., |S(βᵢ,α)|<σ, etc.), the semantic data can be determined based at least in part on the implicit segment representation(s) and/or the implicit object representation. The semantic data can, in some implementations, be defined as a 3D implicit function C(p,α)∈R³. Given a query point pᵢ, the 3D implicit function can return a correspondence point on a canonical mesh X(α₀) as

C(pᵢ,α)=wᵢv_{f}(α₀)=cᵢ,pᵢ*=wᵢv_{f}(α) (6)

where pᵢ* can represent the closest point of p₁ in the mesh X(α), while f can represent the nearest face and w can represent the barycentric weights of the vertex coordinates v_{f}. In contrast to alternative semantic encodings, such as 2D texture coordinates, the semantics function C(p,α) can be smooth in the spatial domain without distortion and boundary discontinuities.

It should be noted that implicit representations (e.g., signed distance functions, etc.) generally return the shortest distance to the underlying implicit surface for a spatial point, whereas implicit semantics generally associate the query point to its closest surface neighbor. Hence, implicit semantics can generally be considered to be highly correlated to learning of implicit representation (e.g., learning to generate signed distance function(s), etc.). As such, the determination of both the implicit object representation and the semantic data—both S(p,α) and C(p,α)—can, in some implementations, be trained and/or performed using the fusing portion of the machine-learned implicit object representation model.

At 610, the computing system can evaluate a loss function. More particularly, the loss function can evaluate a difference between the implicit object representation and ground truth data associated with the object. The loss function can additionally evaluate a difference between the semantic data and the ground truth data. In some implementations, the ground truth data can be or otherwise include point cloud scanning data of the object. For example, a scanning device can be utilized (e.g., a LIDAR-type scanner, etc.) to generate a point cloud indicative of the surface(s) of an object. Alternatively, or additionally, in some implementations, the ground truth data can be or otherwise include a three-dimensional representation of the object (e.g., a three-dimensional polygonal mesh, etc.).

As an example, to train the machine-learned implicit object representation model, a sample point pᵢ, defined for the object, can be transformed into the N localized point sets (e.g., local coordinate frames, etc.) using T₀^{j} and then can be passed to the segment representation portion(s) of the model (e.g., the single-part local multi-layer perceptrons, etc.). The fusing portion of the machine-learned implicit object representation model (e.g., a union SDF MLP, etc.) can then aggregate the shortest distance to the full object among the local distances of the implicit segment representations (e.g., signed distance function(s), etc.). The losses can be applied to the fusing portion as well, to ensure that the output satisfies the SDF property.

In some implementations, the spatial point encoding e₁ requires all samples p to be inside the bounding box B, which may otherwise result in periodic SDFs due to sinusoidal encoding. However, a point sampled from the full object is likely to be outside of an object segments local bounding box B^{J}. Instead of clipping or projecting to the bounding box, the encoding of sample pᵢ can be augmented for segment representation portions S^{j} as eᵢ^{j}=[sin(2π\tilde{p}ᵢ^{j}), cos(2π\tilde{p}ᵢ^{j}), tanh(π(\tilde{p}ᵢ^{j}−0.5))]^{T}, where the last value can indicate the relative spatial location of the sample with regards to the bounding box. If a point pᵢ is outside the bounding box B^{j}, the fusiung portion of the model can learn to ignore S^{j}(pᵢ^{j},α) for the final union output.

As another example, semantics can be trained fully supervised, using an L₁ loss for a collection of training sample points near and on the surface Y. Due to the correlation between tasks, the machine-learned implicit object representation model can predict both an implicit object representation (e.g., a signed distance, etc.), and semantic data, without expanding the capacity of the model. In some implementations, the machine-learned implicit object representation model can be trained using a batch-size of 16 containing 16 instances of a paired with 512 on surface, 256 near surface, and 256 uniform samples each. In some implementations, the loss function can be or otherwise include:

L=λₒ_{₁}Lₒ_{₁}+λₒ_{₂}Lₒ_{₂}+λₑLₑ+λₗλₗ

where Lₒ_{₁} can refer to the first part of Lₒ (distance) and Lₒ_{₂} to the second part (gradient direction), respectively. λₒ_{₁}=1, λₒ_{₂}=1, λₑ=0.1, and λₗ=0.5 can be chosen. Empirically, it is generally found that linearly increasing λₒ_{₁} to 50 over 100K iterations can lead to perceptually better results. In some implementations, the machine-learned implicit object representation model can be trained until convergence using various optimizer(s) (e.g., ADAM optimizer(s), etc.). As an example, the model can be trained using an ADAM optimizer with a learning rate of 0.2×10⁻³ exponentially decaying by a factor of 0.9 over 100K iterations.

In some implementations, the machine-learned implicit object representation model can include one or more neural networks. As an example, the machine-learned implicit object representation model can include a plurality of multi-layer perceptrons. For example, the fusing portion and each of the segment representation portion(s) of the model can be or otherwise include a multi-layer perceptron. In some implementations, a SoftPlus layer (e.g., rather than a ReLU layer, etc.) can be utilized for non-linear activation. For example,

$$SoftPlus ( x ) = \frac{1}{a} ln ( 1 + {e}^{ax} )$$

can be utilized with a=100.

Alternatively, or additionally, in some implementations, a swish function can be utilized rather than a ReLu function. As an example, the machine-learned implicit object representation model can include one 8-layer, 256-dimensional multi-layer perceptron (MLP) for a certain segment of the object (e.g., a body segment of a human body object, etc.), while three 4-layer, 256-dimensional MLPs can be used respectively for three other segments of the object (e.g., two hand segments and a head segment of a human body object, etc.). To follow the previous example, each of the MLPs can include a skip connection in the middle layer, and the last hidden layers of the MLPs can be aggregated in a 128-dimensional fully-connected layer with Swish nonlinear activation before the final network output.

In some implementations, the machine-learned implicit object representation model can include one or more neural networks. As an example, the machine-learned implicit object representation model can include a plurality of multi-layer perceptrons. For example, the fusing portion and each of the segment representation portion(s) of the model can be or otherwise include a multi-layer perceptron. In some implementations, a SoftPlus layer (e.g., rather than a ReLU layer, etc.) can be utilized for non-linear activation. For example,

$$SoftPlus ( x ) = \frac{1}{a} ln ( 1 + {e}^{ax} )$$

can be utilized with α=100.

To follow the previous example, in some implementations, the MLPs can modulate a signed distance field of the body object to match a scan of a body (e.g., point cloud data from a scan of a human body, etc.). For example, distance residuals can be determined from clothing, hair other apparel items, any divergence from a standard human template, etc. The output signed distance of a scan can be conditioned with both the distance and semantic fields of the body defined by ŝ=Ŝ(S(p,α))=Ŝ(s,c). More particularly, Ŝ can be trained separately for specific personalizations. As an example, an instance of Ŝ can be trained for a “dressed human” human body type personalization. As another example, an instance of Ŝ can be trained for a human body type with limb differences personalization (e.g., a personalization for amputees, etc.). In such fashion, the a separate instance of Ŝ can be represented separately from the underlying human body using different layer(s) of the machine-learned implicit object representation model.

In some implementations, the machine-learned implicit object representation model can include one or more fully-connected layers. As an example, the machine-learned implicit object representation model can be or otherwise include eight 512-dimensional fully-connected layers, and can additionally, or alternatively, include a skip connection at the 4th layer, concatenating the inputs with the hidden layer outputs. Alternatively, or additionally, in some implementations, to enable higher-order derivatives, the SoftPlus nonlinear activation can be utilized instead of ReLU as previously described.

In some implementations, if the machine-learned implicit object representation model includes a plurality of segment representation portions, the model can sometimes include a plurality of multi-layer perceptrons. As an example, the object can be a human body object, and can include a head segment, a body segment, and two hand segments. The machine-learned implicit object representation model can include a 8-layer 512-dimensional MLP for the body segment representation portion, two 4-layer 256-dimensional MLPs for the hand segment representation portions, and one 6-layer 256-dimensional MLP for the head segment representation portion. Each segment representation portion can, in some implementations, utilize a SoftPlus nonlinear activation, and can include a skip connection to the middle layer. In some implementations, the last hidden layers of the sub-networks can be aggregated in a 128-dimensional fully-connected layer with SoftPlus nonlinear activation, before the final network output is computed using a (last) fully-connected layer.

In some implementations, the machine-learned implicit object representation model can be or otherwise include a single segment representation portion that is trained to process the entirety of the object (e.g., an object with only one full-object segment, etc.).

In some implementations, various layer(s) of the machine-learned implicit object representation model can be frozen and/or unfrozen during training. As described in a previous example, reconstruction techniques (e.g., triangle soup surface reconstruction, etc.) can be generally performed by optimizing for α=(β_{b},β_{f},θ), such that all observed vertices \hat{v} are close to the implicit surface S(⋅,α)=0. However, in some implementations, after finding the α explaining the observation best, various component(s) of the machine-learned implicit object representation model can be frozen or unfrozen and further optimized to fully match the observation. For example, a last hidden layer of each of the segment representation portion(s) and/or the fusing portion of the model can be unfrozen, combining the part-network outputs. In some implementations, this can lead to training of the machine-learned implicit object representation model such that small changes to object poses still provide for plausible object shapes.

As an example, the machine-learned implicit object representation model trained using the previously described method can be trained using samples of a human object that is wearing non-tight fitting clothing. By overfitting to the observation as previously described, the semantics of the machine-learned implicit object representation model can be transferred to the observed shape, and can be re-posed while maintaining surface details. Additionally, in some implementations, the training of the machine-learned implicit object representation model as previously described can facilitate representation of human shapes without the use of templates, therefore facilitating the implicit representation of people with varying body shapes and/or disabilities (e.g., amputees, etc.).

In some implementations, a three-dimensional mesh representation of the object can be extracted from the implicit object representation. The three-dimensional mesh representation can include a plurality of polygons. As an example, the three-dimensional mesh representation can be extracted from the implicit object representation (e.g., one or more signed distance functions, etc.) using a mesh extraction technique (e.g., a marching cubes algorithm, etc.). In some implementations, after extracting the mesh, the plurality of polygons of the mesh can be shaded based at least in part on the semantic data.

As an example, using trained implicit semantics, textures and/or shading can be applied to arbitrary iso-surfaces (e.g., the polygons of the mesh representation, etc.) at level set |z|≤σ, reconstructed from the implicit object representation. During inference, an iso-surface mesh S(⋅,α)=z can be extracted using a mesh extraction technique (e.g., marching cubes, etc.). Then, for every generated vertex \tilde{v}ₗ, the semantic of the vertex semantics can be queried and represented as C(\tilde{v}ᵢ,α). It should be noted that in some implementations, the queried correspondence point C(\tilde{v}ᵢ,α) may not correspond exactly on the canonical surface of the mesh, and therefore, the correspondence point can be projected onto X(α₀). The UV texture coordinates can be interpolated and assigned to it. Similarly, in some implementations, segmentation labels can be assigned to each vertex \tilde{v}ᵢ based on the semantics C(\tilde{v}ᵢ,α) of the vertex. As an example, the semantic data can be utilized to apply skin shading to a three-dimensional mesh representation of a human body object. As another example, the semantic data can be utilized to apply clothing and/or shading to clothing of a three-dimensional mesh representation of a human body object.

At 612, the computing system can adjust parameters of the machine-learned implicit object representation model based on the loss function. More particularly, the computing system can adjust parameters of the machine-learned implicit object representation model based on the loss function using one or more optimization techniques (e.g., gradient descent, utilization of ADAM optimizer(s), etc.).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method for training a machine-learned model for implicit representation of an object, comprising:
obtaining, by a computing system comprising one or more computing devices, a latent code descriptive of a shape of an object comprising one or more object segments;
determining, by the computing system, a plurality of spatial query points within a three-dimensional space that includes the object;
processing, by the computing system, the latent code and each of the plurality of spatial query points with one or more segment representation portions of a machine-learned implicit object representation model to respectively obtain one or more implicit segment representations for the one or more object segments;
determining, by the computing system based at least in part on the one or more implicit segment representations, an implicit object representation of the object and semantic data indicative of one or more surfaces of the object;
evaluating, by the computing system, a loss function that evaluates a difference between the implicit object representation and ground truth data associated with the object and a difference between the semantic data and the ground truth data associated with the object; and
adjusting, by the computing system, one or more parameters of the machine-learned implicit object representation model based at least in part on the loss function.

2. The computer-implemented method of claim 1, wherein the method further comprises:
extracting, by the computing system from the implicit object representation, a three-dimensional mesh representation of the object comprising a plurality of polygons.

3. The computer-implemented method of claim 2, wherein the method further comprises shading, by the computing system, the plurality of polygons based at least in part on the semantic data.

4. The computer-implemented method of claim 1, wherein the latent code comprises a plurality of shape parameters indicative of a shape of the object and a plurality of pose parameters indicative of a pose of the object.

5. The computer-implemented method of claim 1, wherein:
the object comprises a human body; and
the one or more object segments comprises at least one of:
one or more arms segments;
a head segment;
a body segment comprising a portion of the human body;
a full-body segment comprising a human body;
a torso segment;
a face segment; or
one or more leg segments.

6. The computer-implemented method of claim 1, wherein determining the implicit object representation of the object comprises:
processing, by the computing system, at least the one or more implicit segment representations with a fusing portion of the machine-learned implicit object representation model to obtain the implicit object representation and the semantic data indicative of the one or more surfaces of the object.

7. The computer-implemented method of claim 1, wherein:
prior to processing the latent code and each of the plurality of spatial query points, the method comprises respectively determining, by the computing system based at least in part on the plurality of spatial query points, one or more localized point sets for the one or more object segments, wherein each of the one or more localized point sets comprises a plurality of localized query points; and
wherein processing the latent code and each of the plurality of spatial query points with the one or more segment representation portions comprises, for each of the one or more object segments, processing, by the computing system, the latent code and a respective localized point set with a respective segment representation portion of the machine-learned implicit object representation model to obtain an implicit segment representation for a respective object segment.

8. The computer-implemented method of claim 1, wherein the machine-learned implicit object representation model comprises one or more multi-layer perceptrons.

9. The computer-implemented method of claim 1, wherein the ground truth data comprises at least one of:
point cloud scanning data of the object; or
a three-dimensional mesh representation of the object.

10. The computer-implemented method of claim 1, wherein the implicit object representation comprises one or more signed distance functions.

11. The computer-implemented method of claim 1, wherein the semantic data comprises a plurality of semantic surface coordinates respectively associated with the plurality of spatial query points, wherein each of the plurality of semantic surface coordinates is indicative of a surface of a three-dimensional mesh representation of the object nearest to a respective spatial query point.

12. A computing system featuring a machine-learned implicit object representation model with at least one or more segment representation portions trained to implicitly represent segments of an object, comprising:
one or more processors; and
one or more non-transitory computer-readable media that collectively store a machine-learned implicit object representation model comprising:
one or more segment representation portions, wherein each of the one or more segment representation portions is respectively associated with one or more object segments of an object, wherein each of the one or more segment representation portions is trained to process a latent code descriptive of a shape of the object and a set of localized query points to generate an implicit segment representation of a respective object segment of the one or more object segments; and
a fusing portion trained to process one or more implicit segment representations to generate an implicit object representation and semantic data indicative of one or more surfaces of the object; and
wherein at least the one or more segment representation portions of the machine-learned implicit object representation model have been trained based at least in part on a loss function that evaluates a difference between the implicit object representation and ground truth data associated with the object and a difference between the semantic data and the ground truth data associated with the object.

13. The computing system of claim 12, wherein the machine-learned implicit object representation model comprises one or more multi-layer perceptrons.

14. The computing system of claim 12, wherein the ground truth data comprises at least one of:
point cloud scanning data of the object; or
a three-dimensional mesh representation of the object.

15. The computing system of claim 12, wherein:
the object comprises a human body; and
the one or more object segments comprises at least one of:
one or more arms segments;
a head segment;
a body segment comprising a portion of the human body;
a full-body segment comprising the entire human body;
a torso segment;
a face segment; or
one or more leg segments.

16. One or more tangible, non-transitory computer readable media storing computer-readable instructions that when executed by one or more processors cause the one or more processors to perform operations, the operations comprising:
obtaining a latent code descriptive of a shape of an object comprising one or more object segments;
determining a plurality of spatial query points within a three-dimensional space that includes the object;
processing the latent code and each of the plurality of spatial query points with one or more segment representation portions of a machine-learned implicit object representation model to an implicit object representation and semantic data indicative of one or more surfaces of the object;
determining, based at least in part on the one or more implicit segment representations, an implicit object representation of the object and semantic data indicative of one or more surfaces of the object; and
extracting, from the implicit object representation, a three-dimensional mesh representation of the object comprising a plurality of polygons.

17. The one or more tangible, non-transitory computer readable media of claim 16, wherein the operations further comprise shading the plurality of polygons based at least in part on the semantic data.

18. The one or more tangible, non-transitory computer readable media of claim 16, wherein the latent code comprises a plurality of shape parameters indicative of a shape of the object and a plurality of pose parameters indicative of a pose of the object.

19. The one or more tangible, non-transitory computer readable media of claim 16, wherein:
the object comprises a human body; and
the one or more object segments comprises at least one of:
one or more arms segments;
a head segment;
a body segment comprising a portion of the human body;
a full-body segment comprising the entire human body;
a torso segment;
a face segment; or
one or more leg segments.

20. The one or more tangible, non-transitory computer readable media of claim 16, wherein determining the implicit object representation of the object comprises:
processing at least the one or more implicit segment representations with a fusing portion of the machine-learned implicit object representation model to obtain the implicit object representation and the semantic data indicative of the one or more surfaces of the object.
